(19) United States
(12) Patent Application Publication
(10) Pub. No.: US 2007/0019049 A1
(43) Pub. Date: Jan. 25, 2007

(54) Insert molded print product on demand

(75) Inventors: Saul Heiman, San Diego, CA (US); Thomas A. Liguori, Poway, CA (US)

Correspondence Address: PILLSBURY WINTHROP SHAW PITTMAN LLP, P.O BOX 10500, McLean, VA, 22102, US

(73) Assignee: National Pen Corp., San Diego, CA (US)

(21) Appl. No.: 11/187,369

(22) Filed: Jul. 22, 2005

(51) Int. Cl. B41J 2/01; B41J 29/00

(52) U.S. Cl. 347/101; 347/104

(57) ABSTRACT

A system and process for high speed molding to place printed images, particularly printed color images, on molded objects using a print medium composed of a substrate carrying a coating, the coating being adapted to retain printing inks and formulated to be releasable from the substrate after a molding process. Alternatively, the coating may be formulated to adhere to the substrate after the molding process. The portion of the print medium placed inside may be separated into segments or left in a continuous strip prior to placement in the mold. Images may also be placed on objects by printing directly on the surface of a mold, causing ink from the image to bond to the object formed upon closing the mold and injecting molded material into the mold cavity.

### BACKGROUND

1. Field of the Invention

Embodiments described herein are directed to a process and system for high speed molding to place printed images, particularly printed color images, on molded objects having a variety of sizes and shapes.

2. Description of Related Art

It is known in the art to apply printed color images to various objects, including bottles, packages, writing instruments, or the like, by first printing such images on special coatings provided on substrates, including polyester films, and then transferring the images to the final object. The processes and equipment typically employed for this purpose, generally of the offset or rotogravure type, can be operated economically only in those cases where a very large number of identical images are to be printed. This is true because very high set-up costs are associated with the creation of each image.

In the prior art, an image is separated into four basic process colors, such as cyan, magenta, yellow, and black. A negative is created for each color and a photosensitive printing plate is developed for each negative. Once the four printing plates have been mounted on a press, they are inked and a press “make-ready” registration process is performed. Frequently, this operation takes several hours. As a result, it is considered economically infeasible to use such a process to produce fewer than 20,000 copies of the same ink image. The term “ink,” as used, should be accorded the broadest interpretation such as to encompass all other similar coloring pigmented or dye based agents such as toner.

In view of these economic limitations, when a given design or image is to be produced in small numbers, it is the typical practice to employ silk screening. Silk screening, however, requires the use of multiple screens to produce images composed of a plurality of colors. In addition, care must be taken to properly position, or register, each screen on the object to which the image is to be applied.

Additional problems arise when trying to decorate objects that are rounded, curved, or have surfaces that are otherwise difficult to decorate. To alleviate the problems mentioned, some manufacturers use hot stamping machines to transfer ink prints or images from certain print mediums onto objects to be decorated. The process involves first printing images onto a printing medium, which can be rolled up and delivered to the hot stamping machine. The medium is next carried through the hot stamping machine where, with high temperature and high pressure, the images are transferred from the print medium to objects fed through the hot stamping machine. These processes, however, generally require very specific conditions to be met before the decoration or image is completely transferred to the article. For example, the systems using this process require high temperature in combination with high pressure to be added to the process to encourage the decoration to transfer. Such systems include heaters and pressure rollers, which can be expensive. In addition, because the objects need to be pre-formed, extra space and time are taken to prepare for the image transfer process.

Therefore, there is a need for a versatile printing process that may be adapted to place images of variable data on objects formed through a more efficient process whereby the ink used to form the images becomes incorporated into the surface of the object to be printed.

### BRIEF SUMMARY

A high speed molding process has been developed which uses a one-step process that has both a cost and time advantage over other known processes in the art. The one-step process also substantially allows image transfer to objects without requiring specific conditions to be met, unlike the other known processes in the art.

In embodiments, the process uses digital image processing technology and digitally controlled color printing technology to produce any desired combination of color images onto a print medium. The print medium is placed into one or a series of molds, after which, molding composition is added and a molded object formed. The image is transferred from the print medium to the molded object during the molding process. Additional heaters or pressure rollers are not required to facilitate the transfer, because the heat from the molding process may be sufficient. The print medium being used is composed of a coating and a substrate that allows the print medium to be peeled away from the formed object, after image transfer, rather than tearing or cutting, as in other printing processes. Alternatively, the coating and substrate may be of the type that facilitate adherence to one another after image transfer so that a protective layer is formed over the image on the object.

The high speed molding process provides these different options regarding output format of the printed, molded object by utilizing specific combinations of the coating and substrate. The types of coatings and substrates that can be used may be any that are known in the art. For example, in one embodiment, the coating may be based on a modified acrylic polymer to enhance release from a substrate of Mylar® or polyester film. A substrate using a polyester film of a grade comparable to HS 92 gauge imparts releasability. In alternative embodiments, a substrate of polyester film that is, for example, Corona treated or otherwise chemically treated, to lower the surface tension of the surface, enhances adhesiveness. The use of such a combination will allow the substrate of the print medium to be peeled off of the object after the image transfer, and does not require tearing or cutting. In alternative embodiments, combinations of the coating and substrate may be used to facilitate adherence of the print medium to the object to provide additional protection to the transferred image. Coatings may be composed of styrene acrylic resins, polyglycols, microcrystalline waxes and additives. Various other combinations of coating and substrate may also be used with the process.

Additives may also be used in the process. The additives used may be any that are known in the art. For example, an adhesive agent may be added to the coating of the print medium to further encourage adherence of the print medium to the molded object during the molding process. The print medium becomes a clear protectant layer on the object, preventing the image on the object surface from being faded by the ultraviolet effects of the sun, depending on the film and possible additives used in the coating. The protectant layer may further prevent the image on the object surface from being marred, scratched and the like. If the manufacturer does not need the protectant layer or does not desire a glossy look, a release agent may be added to the coating of the print medium, instead of an adhesive agent. The release agent will further encourage removal of the print medium from the object after the image has been transferred. Because the substrate and coating used can be easily peeled apart, leaving the image on the object surface, the substrate of the print medium may even be left on after the object is molded as a temporary protectant. The print medium may prevent marring, scratching and the like, during shipment to a distributor or an end user. The substrate portion of the print medium may be peeled off of the object at any time, either by choice of the distributor or the end user.

The embodiments of the invention may also include different methods in which the print medium is incorporated into the molding process. One embodiment uses ink prints or images on separated segments of a specific print medium, such as Mylar® or polyester film, to be transferred onto the surface of a molded object. As stated above, the specific print mediums are composed of a special coating, that retains ink prints, and a substrate to which the coating is initially attached. After the molding process, each segment may be removed or left on, depending on the type of coating and substrate used.

In the alternative, the print medium, such as Mylar® film, may be kept in a continuous strip with repeating images attached to the film. The Mylar® film is advanced down a conveyor apparatus so that the film is fitted into a series of molds so that each image fits in a mold. After molding composition is added to each mold, the formed object may be taken out of the mold with the image transferred to the object. The Mylar® film may be removed from each object or trimmed around each object. If the Mylar® film is trimmed around the object, the remaining portion attached to the image may be removed or adhered onto the object as a protective layer.

The Mylar® film segment or trimmed portion may also be removed from the object after the ink print is embedded into the surface at the choice of the end user. The segment may allow the surface of the object to be protected from scratches while it is in transit from the manufacturer to the distributor or retailer and until it reaches an end user. A release agent may be added as part of the coating to facilitate removal of the film from the object after image attachment to the formed object.

### BRIEF DESCRIPTION OF THE DRAWINGS

A detailed description of embodiments of the invention will be made with reference to the accompanying drawings.

FIG. 1 is a simplified pictorial view of one embodiment of the system in accordance with the present invention.

FIG. 2 provides a view of a chart listing some of the most common inks that may be utilized in the present invention, and the substrates to which they adhere most soundly.

FIG. 3 is a cross-sectional detail view of a portion of a print medium utilized in the practice of the present invention.

FIG. 4 is a simplified pictorial view illustrating the steps involved in performing a process of the present invention.

FIG. 5 is a side view of an alternate embodiment of the present invention.

### DETAILED DESCRIPTION

The present invention utilizes digital image processing technology and digitally controlled color printing technology, in a novel combination and configuration with a high speed molding process, to make possible the printing of any desired combination of color images onto molded objects. The process has particular ability to produce objects, including those that are generally flat, with designs or color images formed on one surface. In some embodiments, the related surface is protected from scratching, marring, and the like.

Generally, the print medium is placed into one or a series of molds, after which, molding composition is added and a molded object formed. The image is transferred from the print medium to the molded object during the molding process. Additional heaters or pressure rollers are not required to facilitate the transfer, because the heat from the molding process may suffice. The molding compensation, such as for example, molten plastic, can bond the ink of the image as it touches the surface of the mold. The print medium being used is composed of a coating and a substrate that allows the print medium to be peeled away from the formed object rather than tearing or cutting, as in other printing processes. In alternative embodiments, the coating and substrate may be of the type that cause adherence to one another after the image transfer so that a protective layer is formed over the image on the object.

Because embodiments of the present invention utilizes digital or computerized data, it allows for the economic printing of a small number of objects. These embodiments allow a user to simply select or design the image to be printed and then provide this data via, for example, electronic mail or on computer-readable media. Alternatively, a customer may select or design an image to be printed and provide it to the printer in the form of electronic or digital data. Having customers provide the image or data that they would like printed, in the form that they would like to see the final image, dramatically reduces the front-end costs that are associated with having the person or entity that will perform the printing select and design the image to be printed. Because the printed data is pre-selected and provided by the customer, the printer does not have to prepare proofs of images based on a vague description by the customer, submit them for approval, and re-work them if necessary. Instead, customers can provide exactly what they would like to see printed to the printer. This significantly reduces the front-end costs.

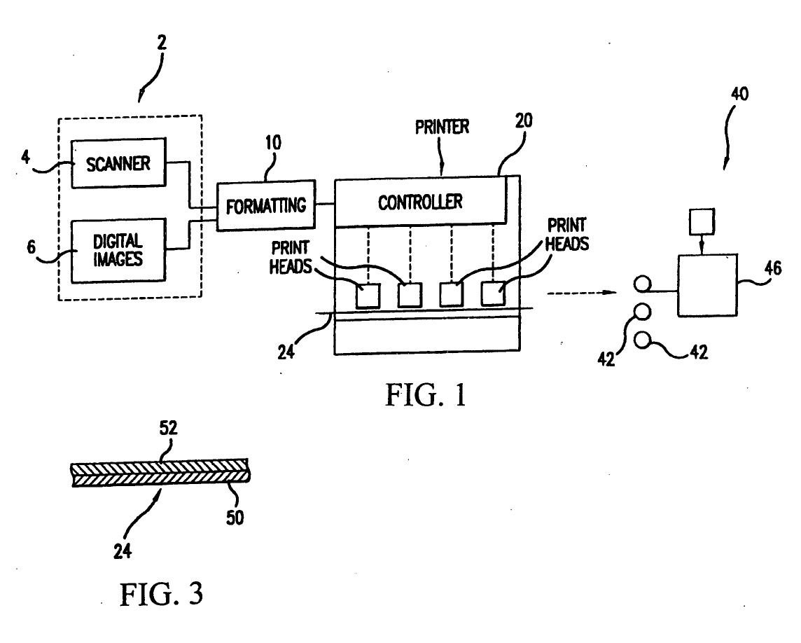

One arrangement for achieving the objects of the present invention is illustrated in FIG. 1. The illustrated system includes a digital data generating station 2 where digital data representing selected images are generated. By way of example, digital data generating station 2 may include a scanner 4 and a memory 6 containing digital image data derived from any external source to generate images. It will be understood that station 2 can consist of other sources of digital image data including a computer terminal connected to receive such data from remote locations including, but not limited to, Internet sites.

All of the data for images to be printed are supplied to a formatting station 10 that performs a variety of tasks. Specifically, in station 10, each image is formatted to the desired size. In addition, data representing each image is associated with position data designating the location at which the image is to be printed.

After data representing a plurality of images has been formatted and associated with position data, the combined data is transferred to the controller of a digitally controlled color printer 20, which is capable of performing full color printing on a print medium in the form of a long web 24. The print mediums may be composed of a special coating 52, that retains ink prints, and a substrate to which the coating is initially attached.

The printer 20 includes four print heads, each for printing black or a respective primary color in order to produce full color prints. Printer control signals may be sent through a connection or link to the print heads to operate each corresponding print head to print images on the desired target. The printer 20 is further equipped to receive an elongated print medium web 24 initially supplied to the printer 20 in the form of a roll 26. The web 24 is unwound from the roll 26 and fed through the printer 20, along a pathway passing each print head in succession. The web 24, as shown in FIG. 3, may be fed through the pathway, such as any commonly used in the art, with the special coating 52 facing the print heads so that images are applied onto the coating 52 as it is fed through machine 46.

The image data may initially be in any commonly used graphic format, a typical example being a Post Script™ format. The data processing system associated with the printer may be of a type which utilizes bit map images and is preferably constructed to directly receive bit map images from any one of the image sources or to convert images in other formats, such as Post Scrip™ formats, into bit map image files.

A suitable printer is a DCP series printer marketed under the trade name XEIKON™ by Xeikon America, Inc. The DCP printer cited above can be controlled by existing software such as the Digital Imaging System marketed by Prime Source Corporation and packaged with DCP printers. This software includes a first subsystem termed a Raster Image Processor which translates postscript information into bitmap image files and a second subsystem termed a Print Engine Supervisor which stores the bitmap files and manages printing conditions within the printer engine. The Raster Image Processor includes Harlequin ScriptWorks software. Operating personnel can interface with the Print Engine Supervisor with the aid of a Windows program entitled Xpose to perform job management functions. Xeikon also has available a front end application program known as the Variable Data System which can be used to produce print jobs with variable data. Print data for controlling color printing of web 24 in a DCP series printer can be entered and formatted using the above-described software and operating instructions supplied therewith by the software publisher.

After the entire length of the web 24 has been printed, it can be fed, for example via a conveyor, from the printer 20 to an image transfer station 40. Depending on the needs and capacity of the image transfer station 40, the web 24 may be cut lengthwise into a plurality of strips 42, where each strip 42 may convey one column of images and may be delivered to the image transfer station 40. Any methods of applying ink that are known in the art, e.g., the XEIKON™ process which uses electrostatic particles of toner, are within the scope of the present invention.

As may be seen in FIG. 1, the image transfer station 40 may include the high speed molding machine 46 which is equipped to mold a series of objects in a manner so that a printed image on the web 24 is brought into position relative to a mold, in which an object will be formed, to transfer the image to the molded object.

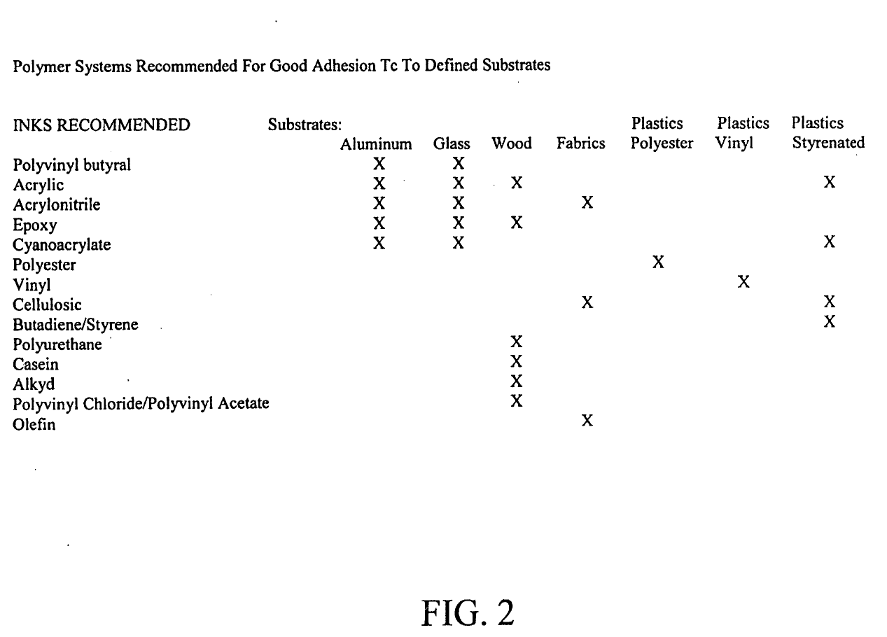

FIG. 2 provides a chart listing some of the most common inks that may be utilized in the present invention and the substrates to which they adhere most soundly. As shown in FIG. 2, inks which may be used in this process include, but are not limited to, polyvinyl butyral, acrylic, acrylonitrile, epoxy, cyanoacrylate, polyester, vinyl, cellulosic, butadiene, styrene, polyurethane, casein, alkyd, polyvinyl chloride, polyvinyl acetate, and olefin inks. The ink used in the present invention is preferably chosen based on, among other factors, its ability to adhere to the substrate being printed, the printer's ability to apply the particular ink, and the like. For example, acrylic, epoxy, polyurethane, casein, alkyd, polyvinyl chloride, and polyvinyl acetate inks are more appropriate for printing on wood, while polyvinyl butyral, acrylic, acrylonitrile, epoxy, and cyanoacrylate inks are more appropriate for printing on aluminum and glass. Further, olefin, cellulosic, and acrylonitrile inks are more appropriate for printing on fabrics.

The method according to one embodiment of the present invention may include adding an additive to the coating. The additive may also be disposed between the coating and the substrate of the print medium. The additive may be placed on the area that is to be covered by the image or such an area that extends beyond the image. The amount of the additive used may vary depending on need or convenience.

For example, an adhesive agent may be added to the coating of the print medium to further encourage adherence of the print medium to the molded object during the molding process. The print medium becomes a clear protectant layer on the object, preventing the image on the object surface from being faded by the ultraviolet effects of the sun, depending on the film and possible additives used in the coating. The protectant layer may further prevent the image on the object surface from being marred, scratched and the like. If the manufacturer does not need the protectant layer or does not desire a glossy look, a release agent may be added as part of the coating of the print medium, instead of an adhesive agent. The release agent will further encourage removal of the print medium from the object after the image has been transferred. Because the substrate and coating used can be easily peeled apart, leaving the image visible on the object surface, the substrate of the print medium may even be left on after the object is molded as a temporary protectant. The print medium may prevent marring, scratching and the like, during shipment to a distributor or an end user. The substrate portion of the print medium may be peeled off of the object at any time, either by choice of the distributor or the end user.

To perform the high speed molding process that involves first printing on a print medium and then transferring the images to a mold as described above, there is provided a specially constructed web 24 which is capable of receiving images in a manner that allows subsequent transfer of those images to surfaces of objects. For this purpose, the web 24 may be composed, as shown in FIG. 3, of a suitable plastic substrate 50 provided with a special coating 52 that is capable of retaining printing ink and of being easily separated from the substrate 50. The special coating 52 is capable of retaining an image that is to be subsequently transferred to a subsequent object. By way of example, substrate 50 may be made of Mylar® and coating 52 may be a removable layer which is formulated to retain an image until the coating is specifically applied against an object being molded for image transfer. After contact with the object being molded, the coating 52 with the image is transferred to the object during the molding process, and separated from the substrate 50. The image transfer to the object may be facilitated by the heat of the molding process and the nature of the coating and substrate used. The molding composition, such as molten plastic, bonds to the ink image on the surface of the mold once it touches the ink.

The coating 52 may be based on an acrylic polymer modified with additives to enhance release from the polyester film 50 and aid in adherence to the target surface of the object. The additives employed may include melamine or urea-formaldehyde resins, microcrystalline waxes, acetylenic diols, plasticizers, solvents, or the like. Additives, such as adhesive agents or release agents, may also be employed and may be any that are known in the art. The coatings may be composed of styrene acrylic resins, polyglycols, microcrystalline waxes and additives. Generally, whether a substrate imparts releasability or adhesiveness of a coating depends on the physical characteristics, such as surface tension, of the surface of the film. For example, a substrate of polyester film of a grade comparable to HS 92 gauge imparts releasability. In alternative embodiments, a substrate of polyester film that is, for example, Corona treated or otherwise chemically treated, to lower the surface tension of the surface, enhances adhesiveness.

The coating 52 may be produced from a solvent based formulation or an emulsion based formulation. The former will generally be applied in the form of a continuous film, while the latter will take the form of a discontinuous film that is converted into a continuous film as a result of coalescense of the emulsion particles under the heat of the molding process. The following are exemplary formulations for each coating type.

1. Solvent Based:

| | |
|---|---|
| Acrylic Resin Solution in Mineral Spirits | 80.0% |
| Mineral Spirits | 12.0% |
| Microcrystalline wax | 8.0% |

2. Emulsion Based:

| | |
|---|---|
| Styrene acrylic emulsion | 55.0% |
| Ammonium Zirconium Carbonate Solution | 13.0% |
| Sodium Polyacrylate Solution | 4.0% |
| Polyoxyethylene Glycols | 0.5% |
| Microcrystalline wax | 10.0% |
| Deionized water | 9.5% |
| Isopropyl alcohol | 8.0% |

According to embodiments of the invention, the acrylic resin of the solvent based composition is isobutyl methacrylate and/or butyl methacrylate polymer, and the styrene acrylic emulsion of the emulsion-based composition is an emulsion copolymer of styrene and 2-ethyl hexyl acrylate and/or butyl acrylate. The above formulas are given only by way of example; other formulations known to be suitable for use as coatings may be used.

Also within the scope of this invention is the use of a coating that has antimicrobial qualities, including antibiotic, antifungal, antiviral, and similar qualities. Since pens and similar writing instruments are often used by many different people, there is the possibility that they could transfer microbes from person to person. One possible solution to this problem is to incorporate sufficient amounts of an anti-microbial agent into the pen body. A problem with such approach, however, is that large quantities of the agent may be necessary to be effective. In the present invention, since only the outer surface of a pen is typically handled, only the outer surface is treated, e.g. by the use of a coating that contains such an antimicrobial agent.

Also within the scope of this invention is the use of a coating that has uv-protective qualities. Such a coating may be used to prevent fading and degradation on products that are exposed to ultraviolet rays, such as, for example, signage.

Either type of coating may be suitably applied to a Mylar® or other polyester substrate by, for example, a continuous web flexographic process or by other known techniques. After application, the coating may be dried under time and temperature conditions suitable for the vehicles employed.

Image data may be obtained simultaneously from a plurality of, i.e., two or more, image sources. Each source may be a scanner, a computer, or the like.

According to the embodiments of the high speed molding process that involve printing first on a web and then transferring the images from the web to the molds, data from a plurality of sources, such as scanner 4 and memory 6 in FIG. 1, is processed and formatted so that the data from each source produces images in a respective column on a web 24, each column extending in the direction of the length of the web and the plural columns being spaced apart in the direction of the width of the web. Such sources may include, but are not limited to, a computer, a scanner, and the Internet. Transmission of images to be printed from remote locations is within the scope of this invention.

As noted above, after printing, web 24 may be slit lengthwise into a plurality of strips 42, each carrying one column of images.

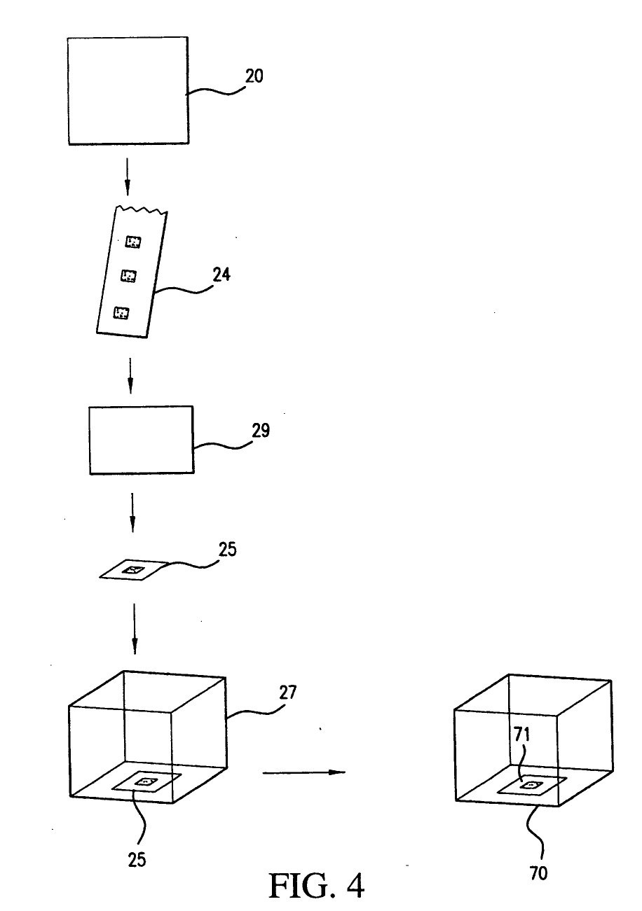

The embodiments of the invention may also include different methods in which the print medium is incorporated into the molding process. In one embodiment shown in FIG. 4, after having been printed, web 24 (only a portion of web 24 is shown) may be separated or cut into a plurality of segments 25 using any separation device 29 known in the art, such as a cutting edge or a pulling force to separate the web 24, or a series of perforations. Such segments 25 may include quadrangles, circles, triangles, or any other shape, whether or not geometric. These segments 25 may be placed, either manually or mechanically, into the bottom of mold 27, with the side that was printed upon facing up or away from the surface of the mold 27. Mold 27 may be incorporated with any molding apparatus or molding means as are currently known in the art. The mold 27 may be designed to form objects that are three dimensional, curved, oddly shaped, or generally flat. Such a mold 27 may then be filled with a molding material such as rubber or plastic, for example, in a manner that is also known in the art. The molding process and the presence of the liquid molding material, which may be any as is known in the art, but is preferably rubber or plastic, causes the image attached to the web 24 to adhere to and become part of the object 70 being molded. As the molding material touches the toner and starts to solidify, the toner adheres to the molding material and becomes integrated into the solidified molding material. The image is thus transferred to the object 70 being molded. The mold 27 then separates and the web 24 can be removed from the molded object 70. The web 24, previously decorated with imagery, becomes devoid of ink, while the newly formed molded object 70 receives the printed image.

Thus, the process produces a molded, decorated object 70. The web 24 may be left on the object 70, which results in a decorated object that is covered by a clear protective layer 71 that may inhibit the removal or damage of the decoration. As described above, an adhesive agent may further be added to the coating of the web 24 as added assurance that the protective layer 71 formed will remain attached to the object 70. Insert molding using this technique allows the decoration to become embedded into the upper surface of the object 70 with the protective layer 71 adhered over it.

In the above embodiment, the web 24 may also be removed from the image print once the image is embedded on the object 70. In this alternative, after the molding process is completed, the substrate 50 of the web 24, such as Mylar®, is removed to leave an image embedded in the surface with a different presentation. By removing the web 24, the image achieved on the object 70 may have a flatter and less glossy look. In addition, a release agent may be added as part of the coating 52 that is applied to the substrate 50 so as to encourage the release of the coating 52 with the image from the web 24 to bind to the object formed by the mold.

In the alternative, the web, or print medium with the attached images, is not cut into segments, but advanced automatically in a continuous strip with an advancing system. To perform the operations described above, a transfer positioning conveyor may be used for advancing mold. Such a conveyor may form a type of assembly line where a number of steps may be performed on the web strip, molds, and/or objects in seriatim. In this embodiment, a print medium, such as Mylar® film, is placed on a conveyor and advanced in a continuous sheet. Images to be embedded onto objects are attached to the Mylar® film, repeating along the entire length of the film. As the Mylar® advances, open molds are placed upon the sheet consecutively at each attached image. A portion of the Mylar® is then fitted into each mold such that a portion of the web overlaps the sides of the mold and extends to the next mold. The portion of the web that is fitted into the mold is positioned such that the image to be transferred or embedded is located within the mold. The mold is then filled with the molding material. The molding process causes the ink of the image to embed into the surface of the forming object. Once a sufficient amount of time has lapsed to allow for proper setting, the molded, decorated object may be withdrawn from the mold. At this point, each formed object may be removed from the Mylar® or the Mylar® film may be trimmed around each formed object as the conveyor advances. The remaining film may continue on the conveyor to be used to pull subsequent foil. Finally, the assembly line of objects with printed images may be placed on an exit conveyor to be later collected.

The Mylar® film segment or trimmed portion may be removed from the object after the ink print is embedded into the surface at the choice of the end user. The segment may allow the surface of the object to be protected from scratches while it is in transit from the manufacturer to the distributor or retailer and until it reaches an end user. A release agent may also be added as part of the coating to facilitate removal of the film from the object after image attachment to the formed object. If so desired, an adhesive agent may instead be added to the coating of the trimmed portion to form a permanent protective layer over the image.

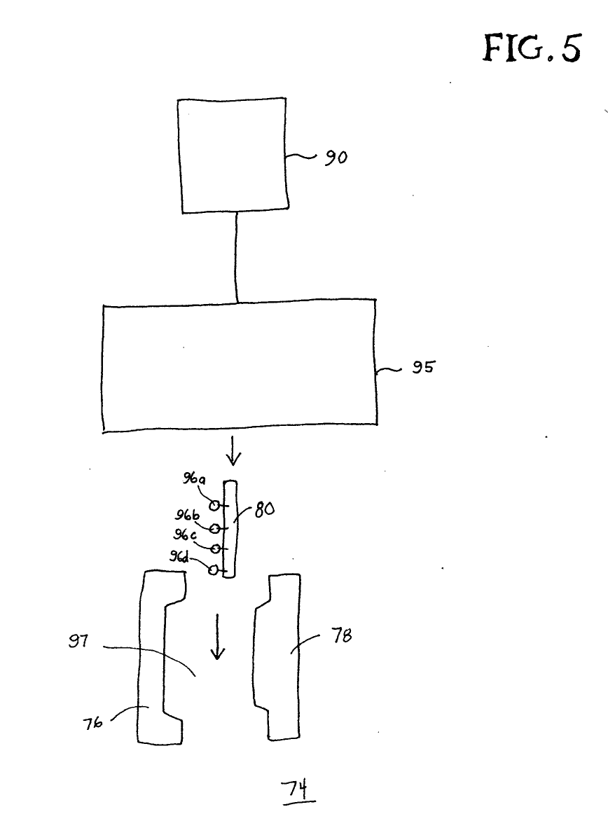

FIG. 5 illustrates another arrangement for achieving the objects of the present invention. The illustrated system includes a digital data generating station 90 where digital data representing selected images are generated. It will be understood that station 90 can consist of any sources of digital image data including a computer terminal connected to receive data from remote locations including, but not limited to, Internet sites. The illustrated system further includes a mold 74 with two parts 76, 78 that join together to form an object. When the two parts 76, 78 join together, molding material, such as plastic, is injected into the mold 74. After the molding material solidifies, the two parts 76, 78 open and release the formed object. The mold 74 may then be prepared to form the next object. The system includes a digitally controlled printer 95. The printer depicted has a plurality of print heads 96(a)-(d) (depicted as separate from the printer for clarification purposes only). The print heads 96(a)-(d) are positioned on a rod 80 connected to the printer 95. The rod 80 can be lowered into the space 97 between the two parts 76, 78 of the mold 74 when the mold 74 is open. Once the rod 80 is lowered into a desired position, the print heads 96(a)-(d) can fire ink directly onto the surface of one or both parts of the mold 74 and move in both a horizontal or vertical position until the image it is printing on the mold surfaces are complete. After the ink image is sprayed onto the mold 74, the rod 80 is removed from between the two mold parts and the two parts 76, 78 of the mold 74 join back together. While only four print heads are shown, it should be understood that the number of print heads may range from as low as one to as many as can be arranged by one skilled in the art around the object to be printed upon.

After data representing an image or a plurality of images has been formatted and associated with position data, the combined data may be transferred to the controller of a digitally controlled printer 95 that is capable of applying an image directly into an open mold 74 without the use of a print medium or web. This direct printing may simplify the printing process by removing the web printing step that is included in some other embodiments. Additionally, the direct printing may be faster than the process involving the transfer of an image from a web onto a molded object. The image or images are transferred directly to the open mold 74, thus eliminating the intermediate transfer of the image from a print medium to the mold.

As with the other embodiments, the printed images, once applied to the mold, can be transferred to virtually any type of object that is made of a material to which the ink forming the images will adhere. The images can be in one or more colors. In an embodiment, the heat from the molding process causes the image to bind to the molding material as it is formed into an object.

The system shown in FIG. 5 may be used to make one object or a series of objects. Each time the mold 74 opens, the rod 80 lowers into a specific position where the print heads 96(a)-(d) can apply the desired image or images into the open mold 74. After the image or images are applied, the two parts 76, 78 of the mold 74 are joined together and molding material is injected into the closed mold 74. The ink sprayed on the inside of the mold 74 will adhere to the molding material as it solidifies and embed the image to the formed object. The system may be used to create one object or a series of objects. If a series of objects are to be made, an exit conveyor may collect and deliver the objects to a specific destination, such as a collection bin.

The arrangement may also be used in connection with print mediums. In one embodiment, a piece of print medium, such as Mylar®, is applied to one part 76 of the mold 74, before the two parts 76, 78 join together, with the ink image exposed to the injected molding material. During the molding process, the ink is bonded to the forming object to create an image on the object. Subsequently, the Mylar® can be peeled off from the object. If a second object is to be made, then another piece of print medium is applied to the one part 76 of the mold 74. In one alternative, a release agent may be added to the coat of the print medium to encourage the removal of the print medium from the object. In a second alternative, an adhesive agent may be added to the coating of the print medium so as to ensure the print medium stays on the surface of the object after the object is removed from the mold 74. As a result, the formed object has incorporated the image on the print medium and the print medium remains over the image, serving as a protectant and also providing a high sheen or glossiness to the object.

It will be understood that the embodiments of the present invention depicted in FIG. 4 and FIG. 5 may include certain features of other embodiments of the present invention including, but not limited to, a formatting station and the ability to receive image data from a plurality of sources.

While the above description refers to particular embodiments of the present invention, it will be understood to those of ordinary skill in the art that modifications may be made without departing from the spirit thereof. The accompanying claims are intended to cover any such modifications as would fall within the true scope and spirit of the present invention.

The presently disclosed embodiments are therefore to be considered in all respects as illustrative and not restrictive; the scope of the invention being indicated by the appended claims, rather than the foregoing description. All changes that come within the meaning and range of equivalency of the claims are therefore intended to be embraced therein.

What is claimed is:

1. A high speed molding process having particular ability to produce objects with color images formed on one surface thereof, the process comprising the steps of:
generating digital data for printing onto a print medium to form a plurality of color images;
providing a print medium composed of a substrate and a coating on the substrate, the coating being adapted to retain printing inks and formulated to be releasable from the substrate after a molding process;
providing a digitally controlled color printer having multiple print heads for dispensing printing inks of different colors;
supplying the generated digital data to the digitally controlled color printer;
feeding the print medium through the printer and past the print heads such that the print heads are operated under control of the generated digital data to print the plurality of color images on one side of the coating;
placing a selected portion of the print medium, containing at least one color image, inside a mold;
adding molding material to the mold, such that the printed side of the selected portion of the print medium contacts the molding material; and
forming a molded object such that the printed side of the at least one of the selected portion of the print medium is visible on the molded object.

2. The process of claim 1, wherein the molded objects are generally flat.

3. The process of claim 1, wherein the coating is formed from one of the group consisting of acrylic resins, styrene acrylic resins, polyacrylates and mixtures thereof.

4. The process of claim 1, wherein the substrate is formed from at least one of the group consisting of polyester resin films and mixtures thereof.

5. The process of claim 1, wherein the molding material is selected from the group consisting of rubber and plastic.

6. The process of claim 1, wherein a release agent is added to the coating to further encourage the substrate portion of the print medium to release from the molded object.

7. The process of claim 1, wherein the print medium is separated into the plurality of segments before placement in the mold by a separation device selected from the group consisting of a cutting edge and perforations.

8. The process of claim 1, wherein the selected portion of the print medium, containing at least one color image, is placed inside the mold such that the portion of the print medium overlaps the sides of the mold and extends to the next mold.

9. The process of claim 8, wherein the print medium is trimmed to remove the portion that overlaps the mold and retains the portion that is attached to the molded object.

10. The process of claim 9, wherein the retained portion of the print medium forms a clear protective coating over the printed side of the molded object until removed by an end user.

11. A system for high speed molding of objects with color images formed on one surface thereof through the intermediary of a print medium, the print medium being composed of a substrate and a coating on the substrate, the coating being adapted to retain printing inks and formulated to be releasable from the substrate after a molding process, the system comprising:
a digital data generating station, wherein the digital data represents at least one color image;
a digitally controlled color printer having a plurality of print heads;
a printing controller connected to the digital data generating station to receive the digital data and for supplying the digital data to the print heads in the form of printer control signals;
a pathway for feeding the print medium through the printer and past the print heads while operating the print heads under control of the printer control signals to print the color images on the coating; and
a mold configured to receive a selected portion of the print medium, whereby after molding material is placed in the mold, a decorated molded object is formed.

12. The system of claim 11, wherein the molded objects are generally flat.

13. The system of claim 11, wherein the coating is formed from one of the group consisting of acrylic resins, styrene acrylic resins, polyacrylates and mixtures thereof.

14. The system of claim 11, wherein the substrate is formed from at least one of the group consisting of polyester resin films and mixtures thereof.

15. The system of claim 11, wherein the molding material is selected from the group consisting of rubber and plastic.

16. The system of claim 11, wherein the selected portion of the print medium received by the mold is positioned such that the printed side will contact the molding material.

17. The system of claim 11, wherein a release agent is added to the coating to further encourage the substrate portion of the print medium to release from the molded object.

18. The system of claim 11, further including a separation device that separates the print medium into segments containing at least one printed color image and wherein each segment is placed into the mold.

19. The system of claim 18, wherein the separation device is selected from the group consisting of a cutting edge and perforations.

20. The system of claim 11, wherein the mold is configured to receive the selected portion of the print medium, containing at least one color image, such that a portion of the print medium overlaps the sides of the mold and extends to the next mold.

21. A high speed molding process having particular ability to produce objects with color images formed on one surface thereof, the process comprising the steps of:
generating digital data for printing onto a print medium to form a plurality of color images;
providing a print medium composed of a substrate and a coating on the substrate, the coating being adapted to retain printing inks and formulated to adhere to the substrate after a molding process;
providing a digitally controlled color printer having multiple print heads for dispensing printing inks of different colors;
supplying the generated digital data to the digitally controlled color printer;
feeding the print medium through the printer and past the print heads such that the print heads are operated under control of the generated digital data to print the plurality of color images on one side of the coating;
placing a selected portion of the print medium, containing at least one color image, inside a mold;
adding molding material to the mold, such that the printed side of the selected portion of the print medium contacts the molding material; and
forming a molded object such that the printed side of the selected portion of the print medium is visible on the molded object.

22. The process of claim 21, wherein the molded objects are generally flat.

23. The process of claim 21, wherein the coating is formed from one of the group consisting of acrylic resins, styrene acrylic resins, polyacrylates and mixtures thereof.

24. The process of claim 21, wherein the substrate is formed from at least one of the group consisting of polyester resin films and mixtures thereof.

25. The process of claim 21, wherein the molding material is selected from the group consisting of rubber and plastic.

26. The process of claim 21, wherein an adhesive agent is added to the coating to further encourage the substrate portion of the print medium to adhere to the molded object.

27. The process of claim 21, wherein the print medium is separated into a plurality of segments before placement in the mold by a separation device selected from the group consisting of a cutting edge and perforations.

28. The process of claim 21, wherein the selected portion of the print medium, containing at least one color image, is placed inside the mold such that the portion of the print medium overlaps the sides of the mold and extends to the next mold.

29. The process of claim 28, wherein the print medium is trimmed to remove the portion that overlaps the mold and retains the portion that is attached to the molded object.

30. The process of claim 29, wherein the retained portion of the print medium forms a clear protective coating over the printed side of the molded object permanently.

31. A system for high speed molding of objects with color images formed on one surface thereof through the intermediary of a print medium, the print medium being composed of a substrate and a coating on the substrate, the coating being adapted to retain printing inks and formulated to be releasable from the substrate after a molding process, the system comprising:
a digital data generating station, wherein the digital data represents at least one color image;
a digitally controlled color printer having a plurality of print heads;
a printing controller connected to the digital data generating station to receive the digital data and for supplying the digital data to the print heads in the form of printer control signals;
a pathway for feeding the print medium through the printer and past the print heads while operating the print heads under control of the printer control signals to print the color images on the coating; and
a mold configured to receive a selected portion of the print medium, whereby after molding material is placed in the mold, a decorated molded object is formed.

32. The system of claim 31, wherein the molded objects are generally flat.

33. The system of claim 31, wherein the coating is formed from one of the group consisting of acrylic resins, styrene acrylic resins, polyacrylates and mixtures thereof.

34. The system of claim 31, wherein the substrate is formed from at least one of the group consisting of polyester resin films and mixtures thereof.

35. The system of claim 31, wherein the molding material is selected from the group consisting of rubber and plastic.

36. The system of claim 31, wherein the selected portion of the print medium received by the mold is positioned such that the printed side will contact the molding material.

37. The system of claim 31, wherein an adhesive agent added to the coating to further encourage the substrate portion of the print medium to adhere to the molded object.

38. The system of claim 31 further including a separation device that separates the print medium into segments containing at least one printed color image and wherein each segment is placed into the mold.

39. The system of claim 38, wherein the separation device is selected from the group consisting of a cutting edge and perforations.

40. The system of claim 31, wherein the mold is configured to receive the selected portion of the print medium, containing at least one color image, such that a portion of the print medium overlaps the sides of the mold and extends to the next mold.

41. A high speed molding process having particular ability to produce objects with color images formed on one surface thereof by placing printed color images directly on a mold, the process comprising the steps of:
generating digital data representing a plurality of color images to form the plurality of color images;
providing a digitally controlled color printer having a plurality of print heads for dispensing printing inks of respectively different colors that is capable of printing directly on molds;
supplying the generated digital data to the printer;
positioning the ink jet heads to a desired location relative to the mold;
firing of the ink jet heads;
adding molding material to the mold, such that the color image contacts the molding material; and
forming a molded object such that the color image is visible on the molded object.
